(19) United States
(12) Patent Application Publication
(10) Pub. No.: US 2010/0332508 A1
(43) Pub. Date: Dec. 30, 2010

(54) METHODS AND SYSTEMS FOR EXTRACTING AND ANALYZING ONLINE DISCUSSIONS

(75) Inventors: Steven Matt Gustafson, Niskayuna, NY (US); Abha Moitra, Scotia, NY (US); Feng Xue, Clifton Park, NY (US); David Brian Bracewell, Schenectady, NY (US); Jesse Neuendank Schechter, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/495,022

(22) Filed: Jun. 30, 2009

(51) Int. Cl. G06F 17/30

(52) U.S. Cl. 707/759; 707/769; 707/723

(57) ABSTRACT

Extracting and analyzing online discussions to identify prospects of a subject is provided. The method has steps including initializing queries related to the subject and a set of data sources utilizing subject information and one or more data source names, extracting the discussions from the set of data sources by employing the queries, extracting significant discussions from the extracted discussions by applying discussions quality methods, identifying websites corresponding to the significant discussions; extracting significant websites by applying websites quality methods to the identified websites, determining a website influence of each of the significant websites by determining their corresponding attributes, identifying a discussion influence of each of the significant discussions based on the website influence of each of the corresponding significant websites, and weighting the significant discussions and the significant websites utilizing the discussion influence and the website influence of each of the significant discussions and the significant websites, respectively.

### BACKGROUND

The Internet is a vital forum for online discussions to share information, commentary, news and opinions about products, services and people. The widespread options available for the online discussions on the Internet typically include blogging and online communications, which include e-mails, postings, web pages, and the like. The Internet, thus, enables people to challenge beliefs and voice their opinions about products, politicians, and so forth. Hence, the comments or opinions made on the Internet may have a direct impact on popularity of products, services, companies, etc.

Further, websites used for the online discussions, such as, blogs typically have a community nature. The community nature of the websites may be defined as interrelationships between groups of websites, and/or interrelationships between the websites of each group, such that some websites are internally linked to other websites to facilitate inclusion of postings of the other websites. The community nature of websites fosters an online “word of mouth nature”, and confers a viral ability to the websites. This viral nature is capable of generating a tremendous amount of hype, negative or positive, around products, services, and the like, which makes monitoring of the online discussions extremely important. The word of mouth marketing typically includes a variety of online resources such as buzz, blog, viral, grassroots, cause and social marketing, and ambassador programs that can rapidly disseminate information and seek to influence others.

The online discussions also enable new ways of marketing, as is evident by the creation of marketing associations, like the “Word of Mouth Marketing Association”, an official trade organization for word of mouth marketing. Many companies are going beyond monitoring of the online discussions, and are also becoming more aggressive in harnessing the online word of mouth nature of the community websites by initiating viral marketing campaigns. These marketing campaigns are typically designed to initiate and guide a viral spread of the desired marketing message.

The success of the monitoring of the online discussions and the viral marketing campaigns is attributed to a number of factors. One important factor is the websites that spread the online discussions and the marketing messages. Thus, the successful monitoring of the online discussions and the viral marketing requires identification of appropriate websites that create an impact by means of the websites postings. The selection of the appropriate websites may include consideration of attributes, such as ability to spread the online discussions and the marketing messages, network metrics, and so forth.

Accordingly, a challenge for successful deployment and monitoring of the online discussions and the viral marketing campaigns is identification of websites that have a tremendous impact on society, credibility of the websites, engagement of active followers, website linkage reflecting the breadth of coverage, and reputation of products and services. Typically, such websites include websites that are frequently visited by people, and are linked to a number of other websites because of their merit or expertise in discussions that revolve around a particular product, service, and the like.

While conventional methods and systems identify websites for the monitoring of the online discussions and the viral marketing campaigns, these conventional methods typically treat all the websites equally, and fail to differentiate the websites based on the impact for different products and services. Thus, conventional methods typically assign equal importance to online discussions from websites having significant impact, and online discussions from websites having slim or no impact. Further, conventional methods identify the websites by implementing web crawling and thus, require a substantial amount of time. Also, conventional methods and systems fail to analyze the identified websites or the online discussions to determine their impact.

Hence, it is highly desirable to develop methods and systems that identify the impactful websites and authoritative online discussions. It is further desirable to develop methods and systems that analyze the online discussions and the websites to identify their impact. It is also desirable to reduce an amount of time required in identifying the impactful websites and the online discussions.

### BRIEF DESCRIPTION

Embodiments of the invention relate generally to a field of monitoring online network communications and more specifically to extracting and weighting significant discussions and significant websites from data sources.

Briefly in accordance with one aspect of the technique, a method for extracting and analyzing discussions to identify prospects of a subject is presented. The method includes initializing queries related to the subject and a set of data sources utilizing subject information and one or more data source names, extracting discussions from the set of data sources utilizing the queries, extracting significant discussions from the extracted discussions, identifying websites corresponding to the significant discussions, extracting significant websites from the identified websites, determining a website influence of each of the significant websites by determining corresponding attributes, identifying a discussion influence of each of the significant discussions based on the website influence of each of the corresponding significant websites, and weighting the significant discussions and the significant websites utilizing the discussion influence of each of the significant discussions and the website influence of each of the significant websites and determining the prospects.

In accordance with another aspect of the present technique, a method for extracting and analyzing discussions to identify prospects of a subject is presented. The method includes initializing queries related to the subject and a set of data sources utilizing subject information and one or more data source names, extracting websites from the set of data sources by employing the queries, extracting significant websites from the extracted websites, extracting discussions from each significant website, identifying significant discussions from the extracted discussions, determining a website influence of each of the significant websites by determining attributes of the significant websites, identifying a discussion influence of each of the significant discussions based on the website influence of each of the corresponding significant websites, and weighting the significant discussions and the significant websites utilizing the discussion influence of each of the significant discussions and the website influence of each of the significant websites.

In accordance with still another embodiment of the present technique, a system for extracting and analyzing discussions to identify prospects of a subject is presented. The system includes a parameter controller configured to construct queries and a set of data sources utilizing subject information and one or more data source names, a website service interface in operational communication with the parameter controller, and configured to interact with the set of data sources to extract discussions from the set of data sources by utilizing the queries, an analysis engine in operational communication with the parameter controller, and configured to extract significant discussions from the extracted discussions, identify websites corresponding to the significant discussions, extract significant websites from the identified websites, determine a website influence of each of the significant websites by determining attributes of the significant websites, identify a discussion influence of each of the significant discussions based on the website influence of each of the corresponding significant websites, and assign weight to the significant discussions and the significant websites by utilizing the discussion influence of each of the significant discussions and the website influence of each of the significant websites.

In accordance with yet another embodiment of the present technique, a system for extracting and analyzing discussions to identify prospects of a subject is presented. The system includes a user interface configured to accept subject information of the subject and one or more data source names, a parameter controller in operational communication with the user interface, and configured to construct queries and a set of data sources utilizing the subject information and the one or more data source names, a website service interface in operational communication with the parameter controller and configured to determine significant websites, an analysis engine in operational communication with the parameter controller and configured to determine significant discussions utilizing the significant websites and assign weight to the significant discussions and the significant websites by utilizing the discussion influence of each of the significant discussions and the website influence of each of the significant websites.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of an exemplary system for analyzing online network communications and extracting and weighting significant discussions and significant websites, in accordance with aspects of the present technique;

FIG. 2 is a diagrammatical view of an exemplary architecture for analyzing online communications and processing for extracting and weighting significant discussions and significant websites, in accordance with aspects of the present technique;

FIG. 3 is a flow chart illustrating an exemplary method for extracting and weighting significant discussions and significant websites, in accordance with aspects of the present technique;

FIG. 4 is a flow chart illustrating an exemplary alternative method for extracting and weighting significant discussions and significant websites, in accordance with aspects of the present technique; and

FIG. 5 is a flow chart illustrating an exemplary method for initializing queries and a set of data sources, in accordance with aspects of the present technique.

### DETAILED DESCRIPTION

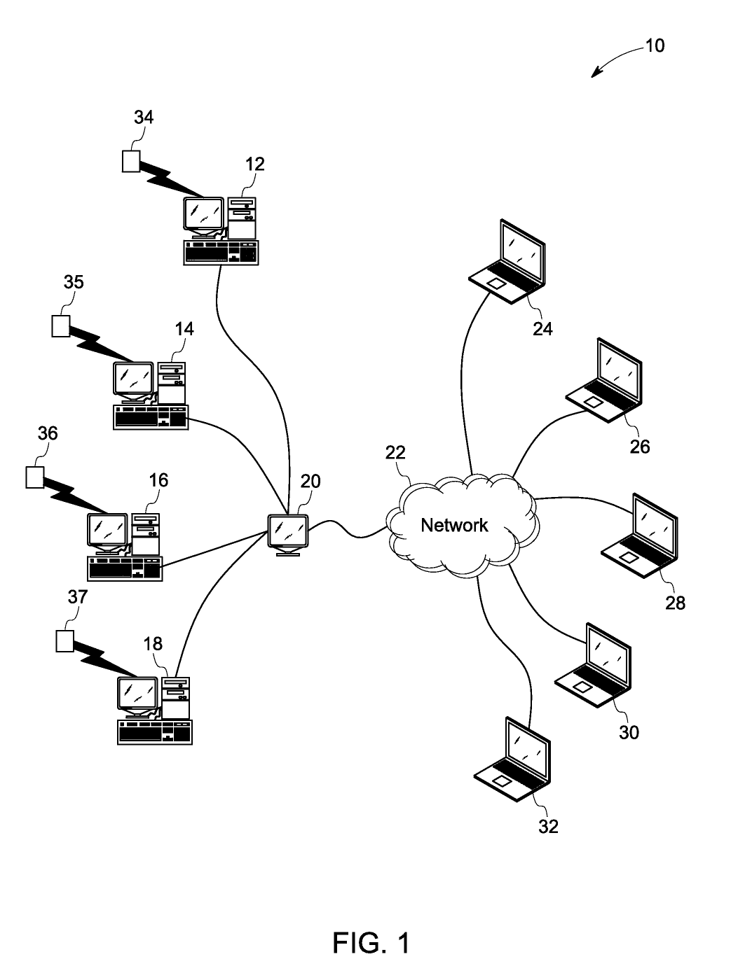

FIG. 1 is a diagrammatical view of an exemplary system 10 for analyzing online network communications and extracting and weighting significant discussions and significant websites, in accordance with aspects of the present technique. In one embodiment, the system 10 includes a plurality of networked client computers. Each client computer may include a user interface configured to communicate information corresponding to a subject and associated one or more data source names entered by a user. Hereinafter, the terms “subject information” and “information corresponding to the subject” may be used interchangeably. In one embodiment, the one or more data source names may include domain names or uniform resource locaters (url) of one or more data sources. In a non-limiting example, the one or more data sources may include websites such as Yahoo Search Web Services, Google Blog Search, TrustedSource, Splogspot, Technorati, and/or OpenCalais.

Further, in one embodiment, the subject may include an object, a person, a commentary, news, an opinion, a product, a service, an organization, an entertainment subject, such as a movie name, and the like. In certain embodiments, content of the subject information may include subject names, synonyms of the subject names, subject attributes, synonyms of the subject attributes, subject modifiers, or combinations thereof. As used herein, the term “subject names” may be used to refer to different names of the subject by which the subject is recognized. Also, as used herein, the term “subject attributes” may be used to refer to key attributes, concepts, parts, or components of the subject that distinguish the subject from other subjects. More particularly, the term “subject attributes” may be defined as key attributes, concepts, parts, or components of the subject that are of interest to the user. For instance, if a subject name is “car”, then the subject attributes may include gas mileage, comfort, cost, etc. Further, as used herein, the term “subject modifier” may be used to refer to one or more terms that facilitate removal of ambiguity from the subject names, the synonyms of the subject name, the subject attributes and/or the synonyms of the subject attributes. For instance, for a subject name “mustang,” a subject modifier may include “car,” with attributes of “model,” “comfort,” “miles per gallon,” etc.

In a presently contemplated configuration, the system 10 is shown as including client computers 12, 14, 16, 18. In one embodiment, the client computers 12, 14, 16, 18 may be interconnected via wireless or wired connections. In certain embodiments, each of the client computers 12, 14, 16, 18 may be connected to the other client computers 12, 14, 16, 18 or to some selected client computers 12, 14, 16, 18. Furthermore, the client computers 12, 14, 16, 18 may be interconnected using local area network (LAN), wide area network (WAN), private networks, or any other network known in the art. As shown in FIG. 1, each client computer 12, 14, 16, 18 may include a corresponding user interface 34, 35, 36, 37, respectively. The user interfaces 34, 35, 36, 37 may be configured to accept the subject information and the one or more data source names entered by the user. In one example, the user interface 34, 35, 36, 37 includes a keyboard, a keypad, a mouse, a touch screen, and a voice actuation incorporating speech to text software.

Furthermore, as shown in the presently contemplated configuration, the client computers 12, 14, 16, 18 are in operational communication with a server 20. Also, as shown in FIG. 1, the server 20 may be in communication with one or more data sources 24, 26, 28, 30, 32 through a network 22. As used herein, the term “one or more data sources” may be used to refer to website servers corresponding to the one or more data source names. In one embodiment, the one or more data source names may be the uniform resource locators of the one or more data sources, such as third party servers.

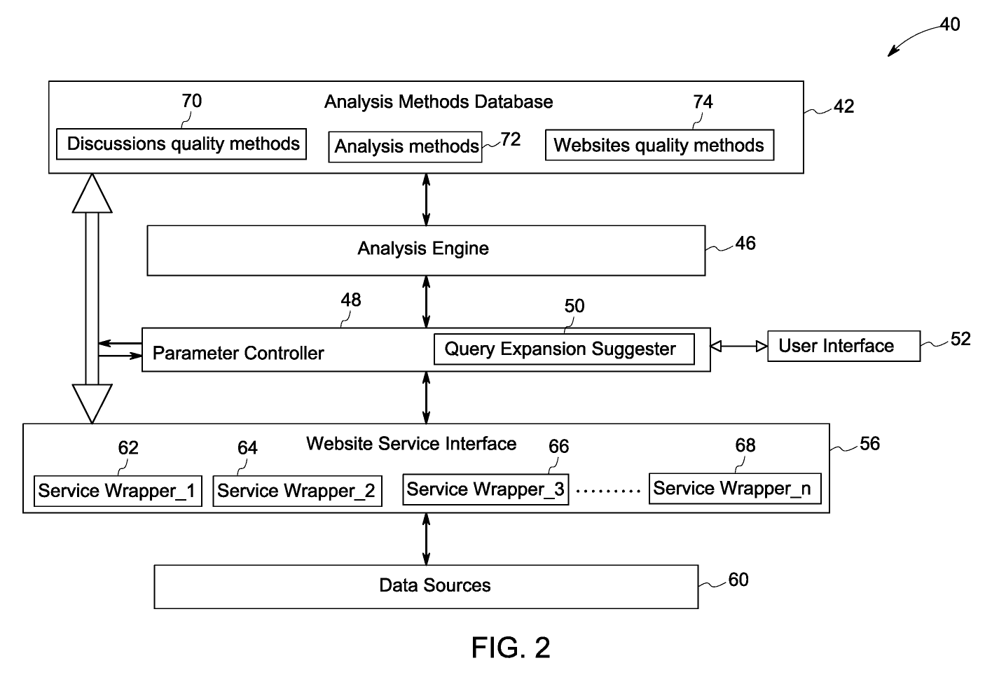

Further, in one embodiment, the server 20 includes an analysis module 25 configured to receive the subject information and the one or more data source names entered by the user at one or more of the client computers 12, 14, 16, 18. It may be noted that while in FIG. 1, the server 20 is shown as including the analysis module 25, in certain other embodiments, one or more of the client computers 12, 14, 16, 18 may include the analysis module 25. Alternatively, both the server 20 and client computers 12, 14, 16, 18 may include the analysis module 25. The analysis module 25 may be further configured to extract and analyze discussions and/or websites from the one or more data sources 24, 26, 28, 30, 32 utilizing the subject information and the one or more data source names. In one embodiment, the discussions may include online discussions. As used herein, the term “online discussions” may be representative of online postings by users having comments or opinions of the users about the subject. The discussions, for example, may include postings by users made on the one or more data sources. The extraction and analysis of the discussions and/or websites from the one or more data sources will be described in greater detail with reference to FIGS. 2-5.

In certain embodiments, the analysis module 25 processes the received information using computer code in order to extract and assign a weight to significant discussions and significant websites utilizing the subject information and the one or more data source names entered by the user. The processing of the received information to extract and assign a weight to the significant discussions and the significant websites will be described in greater detail with reference to FIGS. 2-5. As used herein, the term “significant discussions” may be defined as discussions that may be of interest to the user and may be significant in determining prospects of the subject. As used herein, the term “significant websites” may be representative of websites that may be of interest to the user and may be used for viral marketing and target marketing of the subject. As used herein, the term “prospects” may be representative of an impression, a viewpoint or influence of the subject on the society that determines future existence of the subject in the society.

While in the presently contemplated configuration, the client computers 12, 14, 16, 18 are shown as including corresponding user interfaces 34, 35, 36, 37, in certain other embodiments, the server 20 may also include user interfaces, to enable the user to enter the subject information and the one or more data source names.

FIG. 2 is a diagrammatical view of an exemplary architecture 40 for analyzing the online communications and processing as detailed herein for extracting and weighting significant discussions and significant websites, in accordance with aspects of the present technique. In one embodiment, the architecture 40 may be representative of an architecture of the analysis module 25 (see FIG. 1) in the server 20 (see FIG. 1) for extracting and analyzing discussions and/or websites to identify prospects of the subject and determine target websites for viral marketing and target marketing.

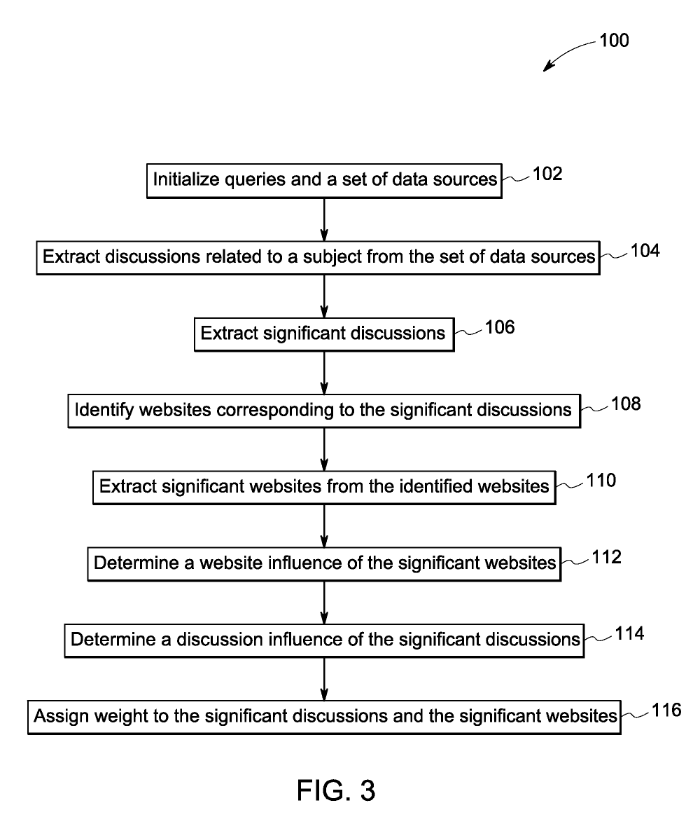

In one embodiment, the architecture 40 includes a parameter controller 48 in operational communication with a user interface 52. In one embodiment, the user interface 52 may be similar to the user interfaces 34, 35, 36, 37 (see FIG. 1). The parameter controller 48 may receive the subject information and the one or more data source names from the user interface 52. In one example, the parameter controller 48 is configured to construct queries and select a set of data sources utilizing the subject information and the one or more data source names, respectively. In one embodiment, the parameter controller 48 may update the one or more data source names to construct the set of data sources. In still another embodiment, the set of data sources may be a subset or superset of one or more data sources 24, 26, 28, 30, 32. The construction of queries and selection of the set of data sources will be described in greater detail with reference to FIGS. 3-5. The set of data sources, for example, may include search engines, blog community websites, websites suggested by a user, or combinations thereof. In a non-limiting example, the set of data sources may include websites such as Yahoo Search Web Services, Google Blog Search, TrustedSource, Splogspot, Technorati, and/or OpenCalais.

Furthermore, the parameter controller 48 may include a query expansion suggester 50 for facilitating construction of the queries and the set of data sources. In one embodiment, the query expansion suggester 50 facilitates construction of the queries by suggesting updated or corrected contents of the subject information and the one or more data source names. The updation or correction of the contents of the subject information and the one or more data source names will be described in greater detail with reference to FIGS. 3-5.

Additionally, the architecture 40 may include a website service interface 56 in operational communication with the parameter controller 48 and data sources 60. In one embodiment, the data sources 60 may be a superset of the set of data sources. In an exemplary embodiment, the data sources 60 may include websites and underlying servers. More particularly, the data sources 60 may include search engine websites, or websites related to a particular domain. In another embodiment, the data sources 60 may be similar to the one or more data sources 24, 26, 28, 30, 32 (see FIG. 1).

Furthermore, in one embodiment, the website service interface 56 is configured to establish a communication link with each of the set of data sources 60. In still another embodiment, the website service interface 56 is further configured to interact with the set of data sources 60 to extract discussions and/or websites from the set of data sources by utilizing the queries. The website service interface 56 includes one or more service wrappers, in certain embodiments. As shown in the presently contemplated configuration, the website service interface 56 includes Service Wrapper_1 62, Service Wrapper_2 64, Service Wrapper_3 66 and Service Wrapper_n 68. In one embodiment, each service wrapper 62, 64, 66, 68 is configured to interact with the set of data sources, and extract the discussions and/or the websites from the set of data sources. In other words, the service wrappers 62, 64, 66, 68 may be configured to provide consistent user interfaces between the data sources 60 and the architecture 40.

In accordance with exemplary aspects of the present technique, the architecture 40 includes an analysis engine 46 in operational communication with the parameter controller 48. In one embodiment, the analysis engine 46 is configured to extract significant discussions from the discussions extracted by the website services interface 56. The analysis engine 46 may extract the significant discussions by applying discussions quality methods 70 to the extracted discussions. As shown in FIG. 2, an analysis methods database 42 may include the discussions quality methods 70. The extraction of significant discussions by applying the discussions quality methods 70 will be described in greater detail with reference to FIGS. 3-5.

In still another embodiment, the analysis engine 46 may be configured to extract significant websites from the websites extracted by the website service interface 56. The analysis engine 46 may extract the significant websites by applying websites quality methods 74 to the extracted websites. As shown in FIG. 2, the analysis methods database 42 may include the websites quality methods 74. The extraction of significant websites by applying the websites quality methods 74 will be described in greater detail with reference to FIGS. 3-5.

Additionally, in certain embodiments, the analysis engine 46 is further configured to assign a weight to each of the significant discussions and the significant websites by utilizing a discussion influence and a website influence of each of the significant discussions and the significant websites, respectively. The analysis engine 46 may determine the discussion influence and the website influence of each of the significant discussions and the significant websites by determining their corresponding attributes. As used herein the term “website influence” may be defined as an impact or influence of the significant websites on society or other websites. More particularly, the term “website influence” may be used to refer to a measurable impact of the significant websites that may be used for identifying appropriate significant websites for target marketing or viral marketing. Also, as used herein the term “discussion influence” may be defined as an impact, influence or authority of the significant discussions on society. The analysis engine 46 may determine the attributes by utilizing analysis methods 72. In one embodiment, the analysis methods database 72 may include the analysis methods. The determination of the discussion influence, the website influence, and the weighting of each of the significant discussions and/or significant websites will be described in greater detail with reference to FIGS. 3-5.

FIG. 3 is a flow chart 100 illustrating an exemplary method for extracting and weighting significant discussions, in accordance with aspects of the present technique. The method starts at step 102, where queries and a set of data sources are initialized. In one embodiment, the initialization of the queries and the set of data sources includes construction of queries and a set of data sources that are initially constructed utilizing the available subject information. Also, in certain embodiments, the construction of the queries includes construction of combinations of the subject names, synonyms of the subject names, the subject attributes, synonyms of the subject attributes, and the subject modifiers. In still another embodiment, the initialization of queries and the set of data sources include updation or corrections of the subject information and the one or more data source names. As previously noted with reference to FIG. 2, the query expansion suggester 50 may facilitate updates or correction of the subject information and the one or more data source names. For example, if the user inserted a subject name as “car”, and subject attribute as “mileage”, then the query expansion suggester 50 may suggest subject names as names of the cars having good mileage, thereby restricting the queries to car names having good mileage. Similarly, the query expansion suggester 50 may suggest new data source names having a domain of discussions similar to domain of discussions of the one or more data source names. More particularly, the query expansion suggester 50 may suggest new data source names that are relevant to the subject information entered by the user. Further to the suggested correction or updation of the subject information and the one or more data source names, the user may accept or reject the suggested subject information and the one or more data source names. In one embodiment, the user may also choose to enter contents of the subject information or one or more new data source names after accepting or rejecting the updated and/or corrected subject information and the one or more data source names.

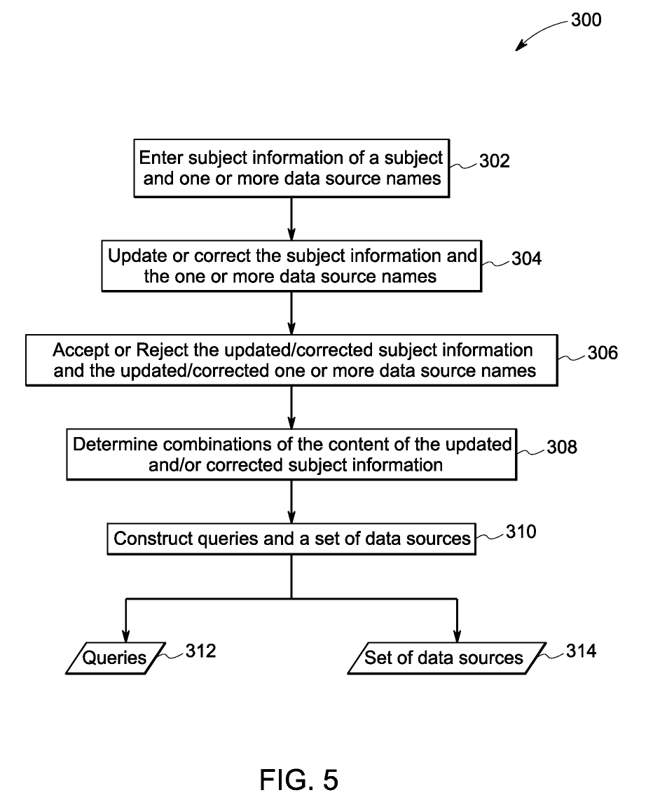

Subsequent to the acceptance or rejection of the updated and/or corrected subject information and the updated and/or corrected one or more data source names, the queries and the set of data sources may be constructed by forming various combinations of the contents of the updated and/or corrected subject information or the subject information. Also, the set of data sources may be constructed utilizing the updated one or more data source names. The initialization of the queries and the set of data sources may be better understood with reference to FIG. 5.

Turning now to FIG. 5, a flow chart 300 illustrating an exemplary method for initializing queries and a set of data sources, in accordance with aspects of the present technique, is depicted. More particularly, step 102 of FIG. 3 is described in greater detail in FIG. 5. The method starts at step 302, where the user enters the subject information and the one or more data source names. In one embodiment, while the user enters the subject information, the entry of the one or more data source names by the user may be optional.

Further, at step 304, the subject information and the one or more data source names may be updated or corrected manually by the user or semi-automatically via tools such as the query expansion suggester 50 of FIG. 2. In one embodiment, the subject information and the one or more data source names may be updated by determining and incorporating synonyms of the contents of the subject information and the one or more data source names. As noted with reference to FIG. 2, the parameter controller 48 may determine the synonyms of the contents of the subject information and the one or more data source names. In one embodiment, the synonyms of the one or more data source names may include data source names having discussions and/or websites relevant to the subject information. In such cases the parameter controller 48 may determine the one or more data source names by analyzing the subject information entered by the user.

Moreover, in one embodiment, when the user enters the subject information and does not enter the one or more data source names, the parameter controller 48 may determine the one or more data source names by analyzing the subject information. For instance, if the user entered the subject information related to a car, then parameter controller 48 may suggest one or more data source names having discussions related to cars, or data source names including web search engines. In one embodiment, the parameter controller 48 may correct the subject information and the one or more data source names by suggesting correct names of the contents of the subject information and the one or more data source names.

In addition, at step 306, the user may accept or reject the updated and/or corrected subject information and the updated and/or corrected one or more data source names. Further at step 308, combinations of the content of updated and/or corrected subject information may be determined. For instance, if the updated and/or corrected subject information includes the subject names such as subject_name_1 and subject_name_2, and the subject attributes as subject_att_1, subject_att_2 and subject_att_3, then the various combinations of the contents of the updated and/or corrected subject information may include (subject_name_1+subject_att_1), (subject_name_1+subject_att_2), (subject_name_1+subject_att_3), (subject_name_2+subject_att_1), (subject_name_2+subject_att_2), and (subject_name_2+subject_att_3).

Further at step 310, the queries and the set of data sources are constructed. In one embodiment, all the combinations of content of the updated and/or corrected subject information may be utilized for construction of the queries. Subsequently, the updated and/or corrected one or more data source names may be utilized for construction of the set of data sources. Reference numeral 312 may be representative of the constructed queries, while reference numeral 314 may be indicative of the constructed set of data sources.

Referring again to FIG. 3, in one embodiment, at step 102, queries 312 (see FIG. 5), and the set of data sources (see FIG. 5) are constructed. Subsequently, at step 104 discussions related to the subject are extracted from the set of data sources for each query. In one embodiment, the discussions related to the subject may be extracted by implementing the queries 312 on the set of data sources 314. As noted with reference to FIG. 2, the website service interface 56 may be configured to interact with the set of data sources 314 to extract discussions from the set of data sources 314 by utilizing the queries 312.

Moreover, at step 106, significant discussions may be extracted from the discussions extracted at step 104. As noted with reference to FIG. 2, the analysis engine 46 (see FIG. 2) may extract the significant discussions by applying discussions quality methods 70 (see FIG. 2) to the extracted discussions. In one embodiment, the discussions quality methods 70 may extract the significant discussions by selecting a predetermined number of most recently posted discussions from each data source of the set of data sources. Thus, in such an embodiment, a combination of the most recently posted discussions for a time period or a selected number of recently posted discussions are extracted from each data source in the set of data sources may be declared as the significant discussions. In still another embodiment, the discussions quality methods 70 may analyze the content of the extracted discussions to identify significant discussions from the extracted discussions. Additionally, in certain embodiments, the discussions quality methods 70 may identify the significant discussions by analyzing amount of the content in each extracted discussion, quality of the content of each extracted discussion, nature of discussions expected, nature of the subject, or combinations thereof.

In addition to the determination of the significant discussions, websites corresponding to the significant discussions may be identified, as indicated by step 108. Further to the identification of the websites, significant websites may be extracted from the identified websites as depicted by step 110. As previously noted with reference to FIG. 2, the analysis engine 46 may extract the significant websites by applying the websites quality methods 74 (see FIG. 2) to the extracted websites. In one embodiment, the websites quality methods 74 may analyze the content of the extracted websites to determine the significant websites. In still another embodiment, the websites quality methods 74 may determine a number of new discussions, a time period between a first discussion and a last discussion, a time period since the last discussion, an average time period for existence of a discussion, an average number of discussions entered per day, and an average number of new discussions entered based on existing discussions on the websites to extract significant websites from the websites. In certain embodiments, the websites quality methods 74 may extract the significant websites that have a number of the significant discussions that is greater than a predetermined threshold value.

In certain embodiments, the queries and the set of data sources may be further updated utilizing the significant discussions, the significant websites, or a combination thereof. In such embodiments, steps 104-110 may be repeated by utilizing the updated queries and the set of data sources to determine new significant websites and new significant discussions. The new significant discussions and the new significant websites may then be added to the previously extracted significant discussions and the significant websites, respectively.

Furthermore, at step 112, website influence of the significant websites may be determined. In certain embodiments, the website influence of each of the significant websites may be determined by determining attributes of each of the significant websites. Also, as previously noted with reference to FIG. 2, the website influence may be determined by the analysis engine 46 by selecting and utilizing one or more of the analysis methods 72 from the analysis methods database 42. In one embodiment, the analysis methods 72 used for determining attributes of the significant websites, for example may include a socially aware method, an in-links method, a page count method, an authority method, a visitors per month method, a freshness method, an affinity method, a suitability method, a context method, or combinations thereof. One embodiment of each of the analysis methods 72 is described hereinafter.

The socially aware method facilitates determination if each of the significant websites enables its discussions to be easily submitted to other websites. The other websites, for example, may include websites that have a domain of discussions that is substantially similar to or dissimilar to a domain of discussions of the significant websites.

Moreover, the in-links method facilitates determination of a number of in-links to each of the significant websites. As used herein, the term “in-link of a significant website” may be defined as a number of pages of websites that have a direct link to the significant website. The in-links method may facilitate estimation of size or connectivity of each of the significant websites along with authority of each of the significant websites. Also, the in-links method may include external in-links method and all in-links method, for example. In one embodiment, the external in-links method determines in-links of each of the significant websites from the websites having discussions relating to the subject. Also, in one embodiment, the all in-links method determines in-links of each of the significant websites from the websites having discussions related to and/or not related to the subject.

In addition, the page count analysis method may facilitate determination of a number of pages of each of the significant websites. In one embodiment, the page count may be dependent on a number of factors, such as, for example the significant website design and/or indexing of the significant website. The page count, for example may be used to determine a size of each of the significant websites, and comparing the size of each of the significant websites with rest of the significant websites.

The authority method may facilitate determination of authority of the significant websites in one or more domains of discussions and/or one or more domains of the subject. As used herein, the term “authority” may be used to refer to an impact of the significant websites on society and other websites. In one embodiment, the other websites may include the significant websites. For instance, a significant website may be more authoritative and impactful in a domain of movies than in the domain of cars, though the significant website accommodates discussions relating to both cars and movies.

Furthermore, the visitors per month method may facilitate estimation of number of people visiting the significant website in a predetermined time period. The predetermined time period, for example, may include a day, a month, a year, and the like.

The freshness method may facilitate determination of everyday volume of discussions on the significant websites. It may also facilitate determination of existence of the significant websites at the time of analysis of the significant websites. In one embodiment, the freshness method may further facilitate determination of an average time period of existence of discussions on a front page of the significant websites. The freshness method may further determine a number of new discussions, a time period between a first discussion and a last discussion, a time period since the last discussion, an average time period for existence of a discussion, an average number of discussions entered per day, and an average number of new discussions entered based on existing discussions on the significant websites.

The affinity method may facilitate determination of an affinity of the significant websites towards the subject. As used herein, the term “affinity” may be defined as an average volume of discussions related to the subject entered in the significant websites over a period of time. In one embodiment, the affinity of significant website towards the subject may be determined by estimating a number of pages of each of the significant websites having discussions related to the subject. In an exemplary embodiment, the number of pages of each of the significant websites may be determined by entering permutations and combinations of the content of the subject information as search keywords on each of the significant websites.

Furthermore, the affinity method may include determination of existence of the subject discussions on the significant website, main affinity, average affinity, number of search keywords with affinity, and number of pages mentioning each search keyword of the significant website. As used herein, the term “subject discussions on the significant website” may be used to refer to presence or absence of one or more discussions related to the subject on the significant websites. As used herein, the term “average affinity” may be used to refer to an average number of pages in each of the significant websites having discussions related to the subject. As used herein, the term “main affinity” may be used to refer to a list containing one or more of the search keywords that results in the largest number of page counts of each of the significant websites. As used herein, the term “number of search keywords with affinity” may be used to refer to a number of the search keywords that resulted in a page count of each of the significant websites greater than zero. As used herein, the term “number of pages mentioning each search keyword” may be used to refer to a list having each of the search keywords with a corresponding page count of each of the significant websites. In one embodiment, each of the page counts may be normalized by dividing each page count by a total number of pages of the corresponding significant website.

In addition, the suitability method may facilitate determination of suitability of the significant websites for target marketing or viral marketing. In one embodiment, the suitability of the significant websites or the websites may be determined by analyzing content of the significant websites. Further, if the content of one or more of the significant websites matches the domain or nature of the subject, then the one or more significant websites may be declared as suitable for viral marketing or target marketing of the subject. For example, if the subject includes a kid's movie, then marketing the kid's movie on the significant website having adult or profane discussions may negatively impact the reputation of the kid's movie and thus, the particular significant website may not be suitable for target marketing and viral marketing.

The suitability method, for example, may analyze the nature or domain of the significant websites by determining profanity, adult content, splog, category, and reputation of the significant websites. As used herein, the term “profanity” may be representative of a number of profane words per predetermined number of words used in each of the discussions of the significant websites. In an exemplary embodiment, if the number of profane words per predetermined number of words in one of the significant websites is greater than a predetermined value, then the particular significant website is not suitable for target marketing or viral marketing. As used herein, the term “adult content” may be representative of percentage of pages having adult discussions or words in each of the significant websites. In an exemplary embodiment, if any of the significant websites have a percentage of pages having adult content more than a predetermined percentage, then the significant website may not be suitable for viral marketing and target marketing.

Further, as used herein, the term “splog” may be representative of a significant website that is used for spamming purposes. In an exemplary embodiment, if any of the significant websites is a spamming website, then it may be disregarded for target marketing or viral marketing. As used herein, the term “category” may be used to refer to a domain, or nature of a significant website. For instance, the category of the significant websites may include entertainment, streaming media, etc. Consequent to determination of the category of the significant websites, the significant websites having a category similar to the subject may be targeted for viral marketing or target marketing of the particular subject. Furthermore, as used herein, the term “reputation” may be used to refer to classification of the significant websites. The classification of the significant websites, for example may include neutral, malicious, suspicious, and the like.

The context method may facilitate examination of discussions of the significant websites to determine how the significant websites are talking about the subject. In one embodiment, the contextual method may include determination of most recent predetermined number of discussions having content around the permutations and combinations of the subject information. In certain embodiments, words in the determined discussions that indicate positive or negative sentiments about the subject may be annotated. The words, for example, may be annotated in Standard Generalized Markup Language format, Extensible Markup Language, Hyper Text Markup Language, and the like. In an exemplary embodiment, the words indicating positive sentiments may be annotated as <+> positive word </+>, and the words indicating negative sentiments may be annotated as <−> negative word </−>. Subsequent to the determination of the positive and negative sentiments in the determined discussions, the context method may also determine number of occurrences of the positive and negative sentiment words.

Following the determination of the website influence of the significant websites at step 112, the discussion influence of the significant discussions is determined at step 114. In one embodiment, the discussion influence may be determined by mapping each of the significant discussions to the website influence of the corresponding significant website. In still another embodiment, the discussion influence of each of the significant discussions may be determined by mapping a discussion influence of each of the significant discussions to a combination of a nature of content of each of the significant discussions, and the website influence of the corresponding significant website.

Further, at step 116, the significant discussions and the significant websites may be weighted by utilizing their corresponding discussion influence and website influence, respectively. In one embodiment, the significant discussions may be weighted such that a significant discussion having a relatively higher discussion influence is assigned a higher weight in comparison to a weight assigned to another significant discussion having a relatively lesser discussion influence. Similarly in another embodiment, the significant websites may be weighted such that a significant website having a high website influence is assigned a higher weight in comparison to another significant website having a relatively lesser website influence.

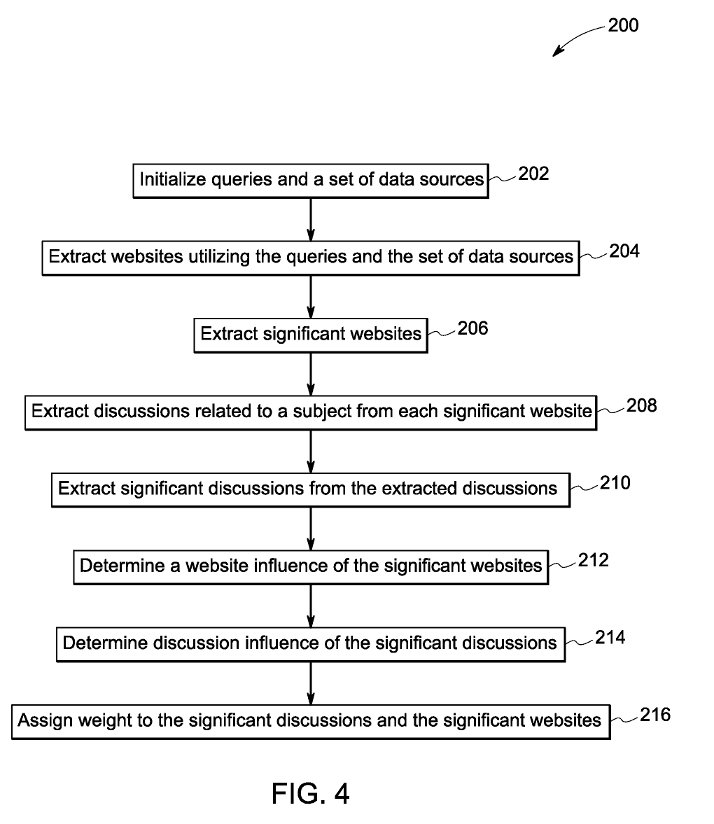

FIG. 4 is a flow chart 200 illustrating an exemplary alternative method for extracting and weighting significant discussions, in accordance with aspects of the present technique. The method starts at step 202, where queries and a set of data sources are initialized. In one embodiment, the initialization of the queries and the set of data sources includes construction of queries and a set of data sources that are initially constructed utilizing the available subject information. As previously noted with reference to FIG. 3, the queries and the set of data sources may include the queries 312 (see FIG. 5) and the set of data sources 314 (see FIG. 5). Furthermore, as previously noted with reference to FIG. 3, the initialization of the queries may include construction of combinations of the subject names, synonyms of the subject names, the subject attributes, synonyms of the subject attributes and the subject modifiers. As further noted with reference to FIG. 3, the initialization of queries and the set of data sources may include updation or correction of the subject information and the one or more data source names. Also, the query expansion suggester 50 may facilitate updation or correction of the subject information and the one or more data source names, as previously noted with reference to FIGS. 2-3.

Subsequent to the construction of the queries and the set of data sources, websites are extracted from the set of data sources utilizing the queries as indicated by step 204. In one embodiment, the websites may be extracted by implementing the queries 312 on the set of data sources 314. Here again as previously noted with reference to FIG. 2, the website service interface 56 may be configured to interact with the set of data sources 314 to extract websites from the set of data sources 314 by utilizing the queries 312.

Furthermore, at step 206, the significant websites may be extracted from the websites extracted at step 204. The analysis engine 46 (see FIG. 2) may extract the significant websites by applying the websites quality methods 74 (see FIG. 2) to the extracted websites as previously noted.

In addition, at step 208, discussions related to the subject may be extracted from the significant websites. Further, at step 210, significant discussions may be extracted from the discussions extracted at step 208. Also, as previously noted with reference to FIG. 2, the analysis engine 46 may extract the significant discussions by applying the discussions quality methods 70 to the extracted discussions. Consequent to determination of the significant discussions at step 210, the website influence of each of the significant websites may be determined at step 212. Further, at step 214, the discussion influence of each of the significant discussions may be determined followed by weighting of the significant discussions and significant websites, as indicated by step 216.

### EXAMPLE

For illustrative purposes, one example is provided to show certain functionality of the present system. Data was collected in this example for a certain time period and the results were analyzed using the tool to demonstrate the functionality of the tool.

This example relates to analysis of the online discussions for the network transition of Jay Leno from the Tonight Show to a new comedy show. The system employs a number of fields such as subject, subject attributes and subject modifiers that can be used to initiate queries. In this example, the following parameters were assigned for this topic:

Subject—The Jay Leno Show; Subject Attributes—Jay Leno, Jay's Garage, Jaywalking, Headlines, monologue, primetime; Subject Modifiers—NBC; Subject Synopsis—“The Emmy-winning host of The Tonight Show comes to primetime. Get ready for the biggest stars, the most influential newsmakers, and more laughter than ever before as Jay Leno hosts a new comedy show five nights a week at 10 pm. His show will be the first-ever entertainment program to be stripped across primetime on broadcast network television and will showcase many of the features that have made Leno America's late-night leader for more than a dozen years. Signature elements will include his opening monologue, new comedy skits, big stunts, and well-known segments like “Headlines” and “Jaywalking.” Jay Leno is transforming television and it's going to be quite a ride.”

In this example, the search query is a combination of Subject, Subject Attributes and Subject Modifiers that are implemented on a number of data sources. Normal boolean searching techniques are utilized and can be further refined using the Subject Synopsis to refine the list to a manageable number.

In order to determine significant discussions, a combination of the Subject, Subject Attributes, and Subject Modifiers, in combination with the Subject Synopsis are used to determine the ‘similarity’ or ‘closeness’ to the retrieved discussions in the results from the search queries. This processing can be reviewed and manually assessed by someone familiar with the topic, it can be semi-automated or fully automated based on models and historical information to properly assess the relevance of the discussions.

Based on the significant discussion identification, the underlying significant websites can be extrapolated. In some cases the significant discussions may overlap or there may be multiple significant discussions associated with one website.

Following the identification of significant websites, the system monitors the websites and collects various aspects of the operation. The time period varies depending upon a number of properties but typically ranges from a few days to a few months. In this example, after several weeks, the following information, as shown in Table 1, was collected for a selected number of significant websites.

TABLE 1

| | |
|---|---|
| Posts collected to date | 577 |
| Posts in last week | 20 |
| Earliest Post | 2009-05-04 |
| Latest Post | 2009-06-21 |

Based on this collected data, the significant websites are further vettted to determine the website influence and the discussion influence that is used to further refine the list of significant websites and discussions for the most significant websites and discussions.

In this example, a sample of four retrieved significant discussions were processed for illustrative purposes. The system performs certain processing and a determination is made as to evaluate the significant discussions and significant websites. In the present example, the system found four significant discussions, in which the following information was extracted. The four significant discussions included significant discussion 1, significant discussion 2, significant discussion 3, and significant discussion 4. The extracted information of significant dicussion 1 is shown in Table 2, the extracted information of significant discussion 2 is shown in Table 3, the extracted information of significant discussion 3 is shown in Table 4, and the extracted information of significant discussion 4 is shown in Table 5.

TABLE 2

| | |
|---|---|
| Discussion | Fall Television Schedule Girl with Remote; Posted on Jun. 21, |
| Title | 2009 by an identifiable party on the significant website. |
| Discussion | . . . Despite the fact that it is probably more of the same, I |
| Snippet | have chosen to underline The Jay Leno Show Please keep |
| | in mind that this schedule is likely to change, particularly |
| | once the fall broadcast season begins and the inevitable |
| | early . . . CBS will also air Primetime Saturday at 8:00 |
| | and 9:00 p.m. and 48 Hours Mystery at 10:00 p.m. NBC * |
| | 30 Rock will replace Community at 9:30-10:00 pm |
| | when it returns in October. Community will move to SNL: |
| | Thursday's 8:00-8:30 slot. . . . |
| Discussion | Neutral |
| Opinion | |
| Discussion | http:// . . . , |
| URL | |
| Discussion | ON-TOPIC |
| Classified | |

TABLE 3

| | |
|---|---|
| Discussion | Tonight's TV Picks: Jun. 21, 2009 The TV Legion; Posted on |
| Title | Jun. 21, 2009 by an identifiable party on a significant website |
| | having 1750 Inlinks (est), 381 Visits (est). |
| Discussion | . . . The Jay Leno Show The Listener, The Marriage Ref, The |
| Snippet | Mentalist, The Middle, The New Adventures of Old Christine, |
| | The Office, The Philanthropist, The Sarah Silverman |
| | Program, The Secret Life of the American Teenager, The |
| | Simpsons, The Vampire Diaries . . . |
| Discussion | Neutral |
| Opinion | |
| Discussion | http: . . . |
| URL | |
| Discussion | ON-TOPIC |
| Classified | |

TABLE 4

| | |
|---|---|
| Discussion | . . . Final Jay Leno Tonight Show The Best Of Jaywalking |
| Title | (HD); Posted on Jun. 21, 2009 on a significant website. |
| Discussion | Beginning in autumn of 2009, he is scheduled to have a |
| Snippet | talk show, tentatively titled The Jay Leno Show which |
| | will air primetime weeknights at 10:00 pm (Eastern Time, |
| | UTC-5), also on NBC Another recurring Related Posts . . . |
| Discussion | Neutral |
| Opinion | |
| Discussion | http: . . . |
| URL | |
| Discussion | ON-TOPIC |
| Classified | |

TABLE 5

| | |
|---|---|
| Discussion | Jay Leno's prime-time show will premiere Sep. 14 (AP); |
| Title | Posted on Jun. 02, 2009 by a identifiable party on a |
| | significant website. |
| Discussion | AP NBC says “The Jay Leno Show” will premiere Sep. 14. |
| Snippet | |
| Discussion | Neutral |
| Opinion | |
| Discussion | http:// . . . |
| URL | |
| Discussion | OFF-TOPIC |
| Classified | |

In these examples, the various attributes are evaluated to determine the influence of each significant discussion and significant website under evaluation. For example, the monitoring shows the spread or viral nature of the discussion, the number of visits, number of threaded discussions, the linkage to other sites and whether the website/discussions are dynamic or stale. The terms in the follow-up discussions are evaluated and can indicate the sentiment and opinions of the discussions as well as the community nature. The information relating to ‘authority’, ‘context’ or sentiment, ‘in-links’, and other parameters are used in determining the website influence and the discussion influence. Since the attributes are typically not equivalent in nature, a weighting process is used based upon the particular nature of the subject and context to make a final determination of the most significant discussions and most significant websites.

The weighting can be performed manually, semi-automatically, or automatically depending upon the nature of the data and the amount of quantifiable historical data. In this example, three of the significant discussions were considered to be on-topic while the last discussion was considered off-topic.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for extracting and analyzing discussions to identify prospects of a subject, the method comprising:
initializing queries related to the subject and a set of data sources utilizing subject information and one or more data source names;
extracting discussions from the set of data sources utilizing the queries;
extracting significant discussions from the extracted discussions;
identifying websites corresponding to the significant discussions;
extracting significant websites from the identified websites;
determining a website influence of each of the significant websites by determining corresponding attributes;
identifying a discussion influence of each of the significant discussions based on the website influence of each of the corresponding significant websites; and
weighting the significant discussions and the significant websites utilizing the discussion influence of each of the significant discussions and the website influence of each of the significant websites and determining the prospects

2. The method of claim 1, further comprising updating the queries and the set of data sources utilizing the significant discussions, the significant websites, or a combination thereof.

3. The method of claim 1, wherein the subject information comprises subject names, synonyms of the subject names, subject attributes, synonyms of the subject attributes, subject modifiers, or combinations thereof.

4. The method of claim 3, wherein initializing the queries comprises constructing combinations of the subject names, synonyms of the subject names, the subject attributes, synonyms of the subject attributes, and the subject modifiers.

5. The method of claim 1, wherein the set of data sources comprises search engines, blog community websites, websites suggested by a user, social networking sites, or combinations thereof.

6. The method of claim 1, wherein extracting the significant discussions from the extracted discussions comprises applying discussions quality methods to the extracted discussions.

7. The method of claim 6, wherein the discussions quality methods extract the significant discussions by selecting a predetermined number of recently posted discussions from each data source in the set of data sources.

8. The method of claim 1, wherein the subject is a product, an entertainment subject, a service, a company, people, synonyms of the product, synonyms of the company, synonyms of the service, or combinations thereof.

9. The method of claim 1, wherein determining the corresponding attributes of the significant websites comprises applying analysis methods to the significant websites.

10. The method of claim 9, wherein the analysis methods comprise a socially aware method, an in-links method, a page count method, an authority method and a visitors per month method, a freshness method, an affinity method, a suitability method, a context method, or combinations thereof.

11. The method of claim 1, wherein weighting the significant discussions and the significant websites comprises assigning a higher weight to a significant discussion having a higher discussion influence and a significant website having a higher website influence than a weight assigned to another significant discussion having a comparatively lower discussion influence and a significant website having a comparatively lower website influence.

12. The method of claim 1, wherein extracting the significant websites from the identified websites comprises applying websites quality methods to the identified websites.

13. A method for extracting and analyzing discussions to identify prospects of a subject, the method comprising:
initializing queries related to the subject and a set of data sources utilizing subject information and one or more data source names;
extracting websites from the set of data sources by employing the queries;
extracting significant websites from the extracted websites;
extracting discussions from each significant website;
identifying significant discussions from the extracted discussions;
determining a website influence of each of the significant websites by determining attributes of the significant websites;
identifying a discussion influence of each of the significant discussions based on the website influence of each of the corresponding significant websites; and
weighting the significant discussions and the significant websites utilizing the discussion influence of each of the significant discussions and the website influence of each of the significant websites.

14. The method of claim 13, further comprising updating the queries and the set of data sources utilizing the significant discussions, the significant websites, or a combination thereof.

15. The method of claim 13, wherein the set of data sources comprises search engines, blog community websites, websites suggested by a user, social networking sites, or combinations thereof.

16. The method of claim 13, wherein determining the attributes of the significant websites comprises applying analysis methods to the significant websites.

17. The method of claim 13, wherein weighting the significant discussions and the significant websites comprises assigning a higher weight to a significant discussion having a higher discussion influence and a significant website having a higher website influence than a weight assigned to another significant discussion having a comparatively lower discussion influence and a significant website having a comparatively lower website influence.

18. The method of claim 13, wherein extracting the significant discussions from the extracted discussions comprises applying discussions quality methods to the extracted discussions.

19. The method of claim 13, wherein extracting the significant websites comprises selecting the significant websites having a number of the significant discussions greater than a predetermined threshold value.

20. A system for extracting and analyzing discussions to identify prospects of a subject, the system comprising:
a parameter controller configured to construct queries and a set of data sources utilizing subject information and one or more data source names;
a website service interface in operational communication with the parameter controller, and configured to interact with the set of data sources to extract discussions from the set of data sources by utilizing the queries;
an analysis engine in operational communication with the parameter controller, and configured to:
extract significant discussions from the extracted discussions;
identify websites corresponding to the significant discussions;
extract significant websites from the identified websites;
determine a website influence of each of the significant websites by determining attributes of the significant websites;
identify a discussion influence of each of the significant discussions based on the website influence of each of the corresponding significant websites; and
assign weight to the significant discussions and the significant websites by utilizing the discussion influence of each of the significant discussions and the website influence of each of the significant websites.

21. The system of claim 20, further comprising one or more client computers, wherein each client computer comprises a user interface configured to accept the subject information related to the subject and the one or more data source names entered by a user.

22. The system of claim 20, wherein the parameter controller further comprises a query expansion suggester configured to update and/or correct the subject information and the one or more data source names.

23. The system of claim 20, further comprising an analysis methods database in operative association with the analysis engine, wherein the analysis methods database comprises discussions quality methods, analysis methods and websites quality methods.

24. A system for extracting and analyzing discussions to identify prospects of a subject, the system comprising:
a user interface configured to accept subject information of the subject and one or more data source names;
a parameter controller in operational communication with the user interface, and configured to construct queries and a set of data sources utilizing the subject information and the one or more data source names;
a website service interface in operational communication with the parameter controller and configured to determine significant websites;
an analysis engine in operational communication with the parameter controller and configured to:
determine significant discussions utilizing the significant websites; and
assign weight to the significant discussions and the significant websites by utilizing the discussion influence of each of the significant discussions and the website influence of each of the significant websites.

25. The system of claim 24, wherein the website service interface is further configured to:
interact with the set of data sources to extract websites from the set of data sources utilizing the queries; and
extract significant websites from the websites utilizing websites quality methods.

26. The system of claim 24, wherein the analysis engine is further configured to:
extract discussions from each of the significant websites; and
apply discussions quality methods to the extracted discussions to identify significant discussions.
